(19) United States
(12) Patent Application Publication
(10) Pub. No.: US 2008/0122567 A1
(43) Pub. Date: May 29, 2008

(54) Spiral inductors on a substrate

(76) Inventor: Jun Su, San Jose, CA (US)

Correspondence Address: TROP PRUNER & HU, PC, 1616 S. VOSS ROAD, SUITE 750, HOUSTON, TX, 77057-2631, US

(21) Appl. No.: 11/513,774

(22) Filed: Aug. 31, 2006

(51) Int. Cl. H01F 5/00

(52) U.S. Cl. 336/200; 29/602.1

(57) ABSTRACT

Reducing the parasitic capacitance between adjacent traces of a spiral inductor can improve the quality factor of the inductor. To reduce the parasitic capacitance, the substrate material adjacent to the traces of the spiral inductor can be removed. The substrate material coupled to the traces of the spiral inductor can remain intact to support the traces and prevent the traces of the spiral inductor from coming into contact with each other.

### BACKGROUND

The embodiments of this invention generally relate to an inductor on a substrate.

Inductors can be created from a spiral trace of a conducting material on a substrate. Inductors can create capacitance between the plurality of traces of the inductor and between the inductor and surrounding materials. The efficiency of an inductor is measured by the quality factor. The capacitance created between the traces of an inductor can lower the quality factor of an inductor. The quality factor for each inductor is determined by the frequency of the signal, the inductance, the capacitance, and the resistance of the traces. An ideal inductor has a quality factor approaching infinity because there is no resistance in the spiral traces.

In an integrated circuit, the spiral traces of an inductor can be in close proximity to each other to reduce the area of the substrate that is used and increase the inductance. To improve reliability, an inductor can be added as a discrete and separate component from the integrated circuit. Adding discrete components can increase the size and cost of a circuit, in some embodiments.

### BRIEF DESCRIPTION OF THE DRAWINGS

FIG. 1 is a perspective view of an embodiment of a spiral inductor on a substrate.

FIG. 2 is an enlarged vertical cross section view of one embodiment shown in FIG. 1.

FIG. 3 depicts a flowchart for one embodiment of a method of manufacturing a spiral inductor on a substrate.

FIG. 4 depicts one embodiment of the circuit representing the characteristics of a spiral inductor on a substrate.

FIG. 5 depicts one embodiment of a system incorporating a spiral inductor.

### DETAILED DESCRIPTION

A spiral inductor can be manufactured on a substrate. In one embodiment, the substrate can also include an integrated circuit. Manufacturing inductors on the same substrate as an integrated circuit can in some embodiments, reduce the cost of including an inductor in a circuit.

A spiral inductor can be created from a trace material winding around the center point at an increasing distance from the center point. The spiral inductor can be in a square, a circle, or another geometric shape.

The efficiency of an inductor is measured by the quality factor. A characteristic of determining the quality factor of an inductor on a substrate is the parasitic capacitance. The parasitic capacitance can be formed between the spiral traces of an inductor and adjacent traces of the inductor. In one embodiment, reducing the parasitic capacitance between the spiral traces of an inductor, can improve the quality factor.

The inductance and the quality factor of an inductor can be affected by two spiral traces coming in contact with one another. Supporting the spiral traces of the inductor with a substrate material can, in one embodiment, improve the reliability by reducing the possibility that two adjacent traces of the spiral inductor can come in contact with one another. Creating trenches adjacent to the spiral traces of an inductor can remove the substrate material and may reduce parasitic capacitance, in one embodiment.

Substrate islands can be created between the trenches and the spiral traces can be attached to the islands. The substrate islands can, in one embodiment, support the spiral traces of an inductor.

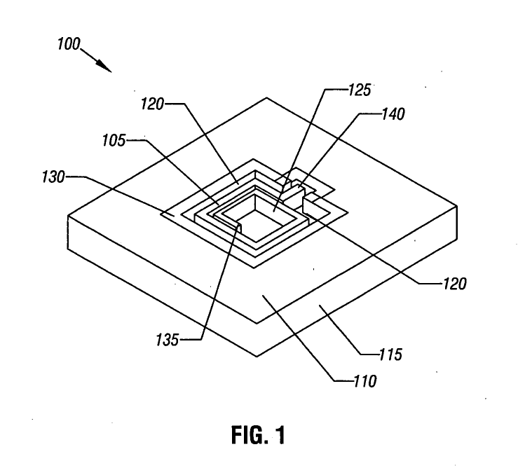

With reference to the figures, FIG. 1 is a perspective view of an embodiment of a spiral inductor 100 on a substrate 115. The spiral inductor 100 can be made from a spiral trace 105. The spiral trace 105 can have a first terminal 135 and a second terminal 140. The first terminal 135 and the second terminal 140 can be used to connect the spiral inductor to other components in an integrated circuit. The first terminal 135 can be coupled to an electrode on another layer through a via. A via can be a path from the first terminal 135 to an electrode material on another layer. The electrode material can connect the first terminal 135 to an integrated circuit. The second terminal 140 may be connected to a radio frequency input output device, in one embodiment. The second terminal 140 may be connected to a capacitor in some embodiments to create an inductance capacitance (LC) circuit.

The spiral trace 105 can be applied to the surface 110 of the substrate 115. Trenches 120 can be formed between adjacent spiral traces 105. Substrate islands 125 can remain between the trenches to support the spiral trace 105. In one embodiment, a ground trace 130 can be applied to the surface of the substrate 110 surrounding the spiral trace 105. A trench 120 can be formed between the spiral trace 105 and the ground trace 130, in some embodiments.

The spiral trace 105 can be a conductor. For example, conductors that may be used include aluminum, copper and gold. The substrate 115 may be a semiconductor, for example, silicon, or gallium arsenide.

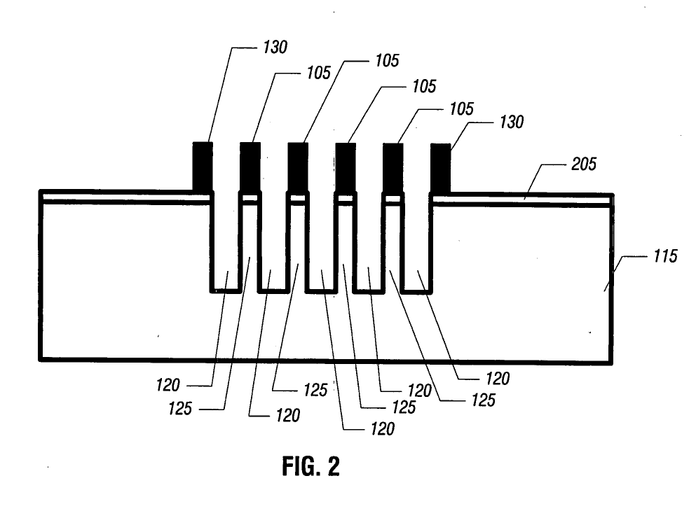

FIG. 2 is an enlarged vertical cross section view of one embodiment shown in FIG. 1. The spiral traces 105 of the inductor can be coupled to islands 125 of substrate material. Layers of other materials may be between the substrate 115 and the spiral traces 105, for example an oxide layer 205 such as silicon dioxide may be between the spiral traces 105 of the inductor and the substrate islands 125.

Between the islands 125, the substrate material 115 can be removed to create a trench 120. The trenches 120 can be filled with a material having a low dielectric constant. In one embodiment, the dielectric material contained in the trenches 120 can be a gas. Examples of gases with low dielectric constants can be oxygen, nitrogen, and combinations of dielectric gases. Surrounding the spiral traces 105 can be the ground traces 130, in one embodiment. The substrate material 115 can be removed between the spiral traces and the ground traces 130, in one embodiment, to form a trench 120.

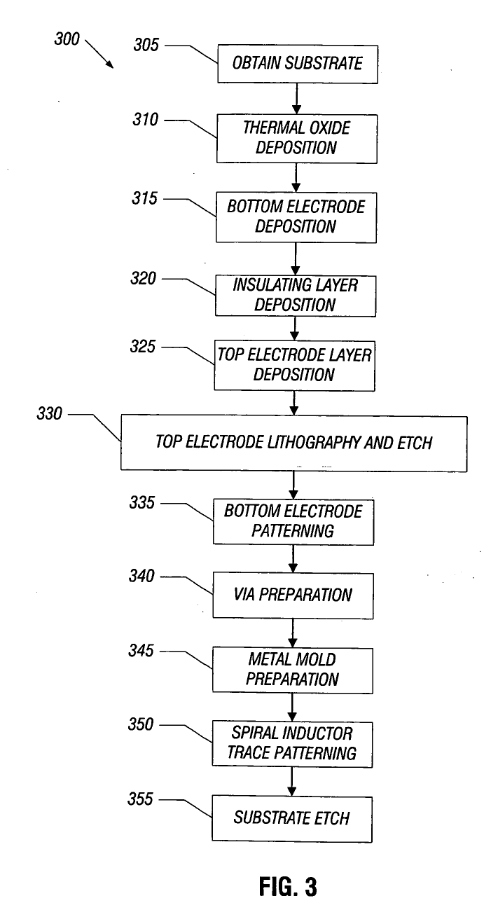

FIG. 3 depicts a flowchart for one embodiment of method of manufacturing a spiral inductor on a substrate. The method of manufacturing a spiral inductor 300 can begin by obtaining a substrate such as silicon at block 305. At block 310, a thermal oxide can be deposited on the substrate. The thermal oxide layer can be applied to increase the resistance of the substrate. An increased resistance can, in some embodiments, improve the radio frequency characteristics of the inductor. A bottom electrode can be deposited on the thermal oxide at block 315. The bottom electrode can connect the inductor to an integrated circuit. An insulating layer can be deposited at block 320. In one embodiment, the insulating layer can be silicon nitride.

A top electrode can be deposited at block 325 onto the insulating layer. In one embodiment, the top electrode can be aluminum. Lithography can be used to create a spiral trace pattern on the top electrode and the pattern can be etched at block 330.

The bottom electrode can be patterned at block 335. Patterning the bottom electrode at block 335 can create traces used to connect the spiral inductor to components of an integrated circuit. Vias can be prepared in the substrate at block 340 to electrically couple the bottom electrode to the top electrode.

A metal mold can be prepared at block 345. The metal can be, for example, gold, copper, or another material with a higher conductivity than aluminum. A material with higher conductivity than aluminum can, in one embodiment, increase the quality factor of an inductor by reducing the resistance in the inductor traces. In one embodiment, the metal may be 6 μm thick on a substrate with a thickness of 250 μm. The thickness of the substrate can be measured from the surface of the substrate at a 90-degree angle to the surface.

The spiral inductor traces can be patterned and etched at block 350. The patterning and etching of the spiral inductor traces at block 350 can be used to restore the traces of the spiral inductor created at block 330. A mask can be applied to the traces. The substrate between the traces of the spiral inductor can be etched at block 355. In one embodiment, the substrate can be etched 100 μm from the surface of the substrate, but can be etched other amounts based on the characteristics of the inductor and substrate.

Etching the substrate material with dry isotropic etching can remove the substrate material not covered by a mask, for example a photo resist. Dry etching can remove substrate material not masked by exposing the material to a bombardment of ions. In some embodiments, a dry etching process can create trenches with substantially parallel side walls with less removal of substrate areas that are covered by a photo resist than a wet etching process.

The volume of a trench with substantially parallel walls can be larger than a trench with walls at an angle to the surface of the substrate. In some embodiments, increasing the volume of the trench can increase the amount of the material with a low dielectric constant in the trench and reduce the parasitic capacitance of the inductor.

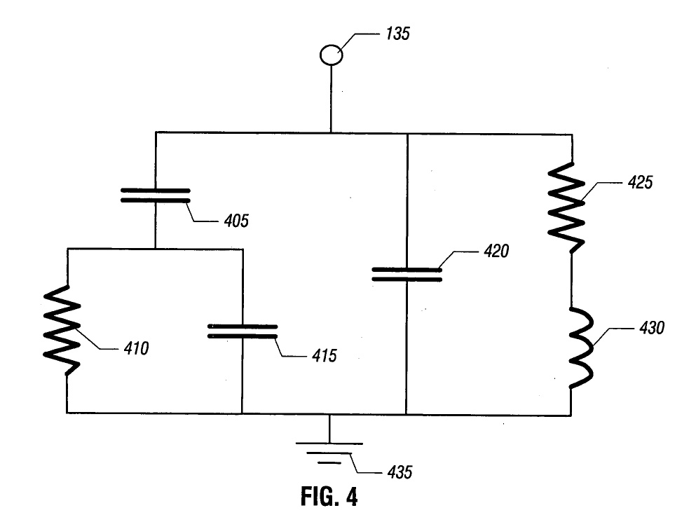

FIG. 4 depicts one embodiment of the circuit representing the characteristics of a spiral inductor on a substrate. The input 135 of the spiral inductor is connected to electronic components representing different characteristics of a spiral inductor on a substrate. The shunt capacitance of the oxide layer 405 is in series with the shunt resistance due to substrate losses 410 and the total shunt capacitance of the substrate 415. The shunt resistance 410 and the total shunt capacitance of the substrate 415 are in parallel and connected to ground 435 if the spiral inductor has a single terminal.

A parasitic capacitance 420 represents the capacitance between the inductor traces. The parasitic capacitance 420 is coupled between the input 135 and the ground 435. The resistance 425 of the trace material of the spiral inductor is in series with the spiral inductance 430. The resistance 425 and the spiral inductance 430 are in parallel with the parasitic capacitance 420.

Removing materials of high dielectric constant such as silicon dioxide and silicon from areas surrounding a spiral inductor can reduce the parasitic capacitance between inductor turns, in some embodiments. A reduction in the parasitic capacitance can lead to higher resonance frequencies of the inductor and an enhancement in the quality factor. The quality factor is represented by

$$Q = \frac{ω {L}_{s}}{{R}_{s}} \cdot \frac{{R}_{p}}{{R}_{p} + [ {( ω {L}_{s} / {R}_{s} )}^{2} + 1 ] {R}_{s}} \cdot [ 1 - \frac{{R}_{s}^{2} ( {C}_{s} + {C}_{p} )}{{L}_{s}} - {ω}^{2} {L}_{s} ( {C}_{s} + {C}_{p} ) ]$$

$$where$$

$${R}_{p} = \frac{1}{{ω}^{2} {C}_{ox}^{2} {R}_{sub}} + \frac{{{R}_{sub} ( {C}_{ox} + {C}_{sub} )}^{2}}{{C}_{ox}^{2}} , \\ {C}_{p} = {C}_{ox} \frac{1 + {ω}^{2} ( {C}_{ox} + {C}_{sub} ) {C}_{sub} {R}_{sub}^{2}}{1 + {ω}^{2} ( {C}_{ox} + {C}_{sub} ) {R}_{sub}^{2}}$$

and where Lₛ represents the spiral inductance, Rₛ the metal series resistance, Cₛ the parasitic capacitance between the inductor turns, Cₒₓ the shunt capacitance of the oxide layer, R_{sub} the shunt resistance due to substrate losses, and C_{sub} the total shunt capacitance of the substrate. The substrate etching in the substrate surrounding the inductor traces can be partially replaced by a material with a low dielectric constant such as a dielectric gas instead of other materials of high dielectric constant such as silicon dioxide and silicon. Replacing materials having a high dielectric constant with materials having a low dielectric constant can reduce Cₛ leading to an inductor with a higher resonance frequency and an improved quality factor.

In one hypothetical example an inductor has a spiral inductance of 1.36 (nH), a shunt resistance due to substrate losses of 2530 (ohms), a shunt capacitance of the oxide layer of 165.1 (fF), a total shunt capacitance of the substrate of 290 (fF). Etching the substrate between the inductor traces can reduce the metal resistance to 0.66 (ohms) from 0.73 (ohms) and reduce the parasitic capacitance from 85.2 (fF) to 50.1 (fF). The quality factor of the hypothetical inductor increases from 38.6 to 45.3 at a resonance frequency of 5.2 GHz, a 17.4% increase in the quality factor, when the inductor substrate is etched between the traces.

In one embodiment, the trenching of the substrate material adjacent to the spiral traces of the inductor increases the quality factor of a resonator by 2.5 dB.

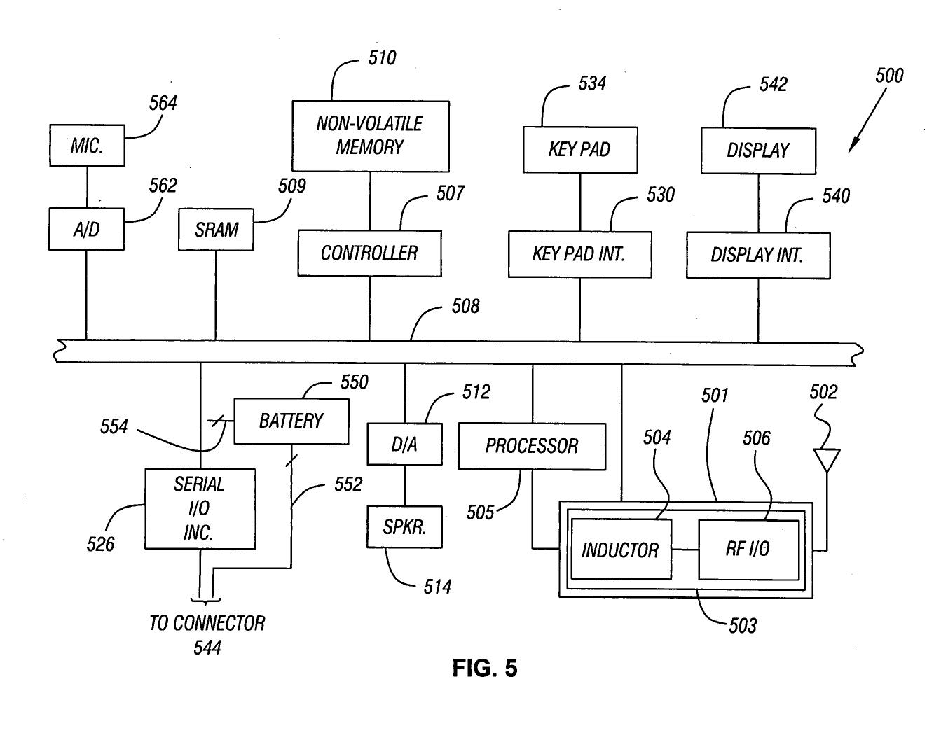

FIG. 5 depicts an embodiment of a system incorporating a spiral inductor. The system may be for example a cellular telephone 500 but is not limited to a cellular phone 500. The cellular telephone 500 includes a communication unit 501 that serves as an interface of the cellular telephone 500 to a cellular antenna 502. The communication unit 501 can include a filter 503 with an inductor 504 connected to a radio frequency input output device 506. The communication unit 501 can be a transmitter, receiver, or a transceiver. The communication unit 501 is coupled to a bus 508 of the cellular telephone 500 to communicate data with a memory 509, for example a static random access memory (SRAM) of the cellular telephone 500. A processor 505 can refer to a multi-core processor. The processor 505 can be coupled to the bus 508 to direct the communication of data between the memory 509 and the communication unit 501. In this manner, if incoming data is received, the processor 505 can transfer the data from the memory 509 to a digital-to-analog converter 512 to a speaker 514 to play audio. Similarly, the processor 505 directs captured voice data from a microphone 564 through an analog-to-digital (A/D) converter 562 to the memory 509.

The cellular telephone 500 can include an input/output (I/O) interface 526 that establishes electrical connection with the connector 544. In this manner, the I/O interface 526 may receive code from the connector 544, and the code can be sent from the processor 505 to the controller 507 to store on the non-volatile memory 510.

Among the other features of the cellular telephone 500, a key pad 534 may be used to enter telephone numbers and may be interfaced between the bus 508 via a keypad interface 530. Furthermore, the processor 505 may drive a display 542 through a display interface 540 that is coupled between the display 542 and the bus 508. The cellular telephone 500 also includes a battery 550 that is coupled to conductive traces, or lines 554, to supply power to the components of the cellular telephone and is coupled to conductive traces, or lines 552, that extend to and are accessible through the connector 544. The lines 552 may be used for purposes of charging the battery 550.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
creating a trench in a spiral inductor to reside between islands of substrate material and between adjacent traces.

2. The method of claim 1, including applying a silicon dioxide layer between the spiral inductor and the substrate material.

3. The method of claim 2, wherein the substrate material includes silicon.

4. The method of claim 1, including coupling the spiral inductor to a radio frequency input output device.

5. The method of claim 4, including coupling the spiral inductor to a capacitor to form an inductance capacitance (LC) circuit.

6. The method of claim 1, including reducing the capacitance between a trace of the spiral inductor and at least one other trace of the spiral inductor.

7. The method of claim 1, including a dielectric material in the trench.

8. The method of claim 7, including providing substantially parallel sides in the trench to increase the volume of the dielectric.

9. A method comprising:
etching a substrate in a spiral to reduce the capacitance generated by a spiral trace of a spiral inductor.

10. The method of claim 9, including applying a silicon dioxide layer between the traces and the substrate.

11. The method of claim 10, wherein the substrate includes silicon.

12. The method of claim 9, including coupling the spiral inductor to a radio frequency input output device.

13. The method of claim 12, including coupling a capacitor to the spiral inductor to form an inductance capacitance (LC) circuit.

14. The method of claim 9, including preparing a metal mold on the inductor prior to etching the substrate.

15. The method of claim 14, wherein the metal has a conductivity greater than aluminum.

16. A device comprising:
an inductor including spiral trace coupled to a substrate; and
a trench created in the substrate adjacent to the spiral trace.

17. The device of claim 16, including a silicon dioxide layer between the spiral traces and the substrate.

18. The device of claim 17, wherein the substrate includes silicon.

19. The device of claim 16, including a radio frequency input output device coupled to the inductor.

20. The device of claim 16, including a capacitor coupled to the inductor to form an inductance capacitance (LC) circuit.

21. The device of claim 16, including substantially parallel sides in the trench.

22. The device of claim 16, including a dielectric in the trench to lower the parasitic capacitance.

23. A system comprising:
a communication unit with a spiral inductor supported by a substrate material with trenches in the substrate material adjacent to traces of the spiral inductor;
a processor coupled to the communicator; and
a static random access memory coupled to the processor.

24. The system of claim 23, including the trench comprising substantially parallel walls.

25. The system of claim 23, including a dielectric in the trenches.

26. The system of claim 25, wherein the dielectric includes a gas.

27. The system of claim 23, wherein the communication unit is a transmitter, a receiver, or a transceiver.
